(19) United States
(12) Patent Application Publication
(10) Pub. No.: US 2007/0244595 A1
(43) Pub. Date: Oct. 18, 2007

(54) Method and means for ultrasonic impact machining of surfaces of machine components

(75) Inventors: Efim S. Statnikov, Birmingham, AL (US); Vladimir N. Vityazev, Severodvinsk (RU)

Correspondence Address: FOLEY AND LARDNER LLP;SUITE 500, 3000 K STREET NW, WASHINGTON, DC, 20007, US

(73) Assignee: U.I.T., LLC, Birmingham, AL (US)

(21) Appl. No.: 11/405,523

(22) Filed: Apr. 18, 2006

(51) Int. Cl. G06F 19/00

(52) U.S. Cl. 700/160; 148/558

(57) ABSTRACT

A method for ultrasonic impact machining (UIM) of straight or curved surfaces using a tool with a free rod-shaped indenter to execute ultrasonic impacts by an action of the tool natural vibrations and ultrasonic transducer resonance oscillations, with goals of strengthening a surface, increasing hardness, creating compressive stresses, and/or modifying surface structure based upon diminishing mosaic blocks up to an amorphous structure is disclosed. These physical effects result in at least one of increased abrasive damage resistance, increased contact injury resistance, increased corrosive damage resistance under stress, increased endurance, increased resistance to fatigue and dynamic fractures, creation of conditions for forming prescribed physical and mechanical properties in the surface. The method provides machining of external and internal faces of straight and curved shapes, and provides indenter axis orientation perpendicular to a workpiece surface at every point of mechanical trajectory of the tool.

### FIELD OF INVENTION

The present invention relates to an area of machining of metal parts by surface plastic deformation with goals of surface strengthening, creating compressive stresses in a surface layer, and improving surface roughness, and modifying a surface layer structure.

### BACKGROUND OF THE INVENTION

Methods and devices for ultrasonic strengthening machining of parts of machine building, using balls, cylindrical rods and indenters of other shapes as deforming elements, fixed to the output end of an ultrasonic waveguide or moving freely along the axis of an ultrasonic tool are known.

Russian Patent No. 1,523,316 describes a method of forming a given microrelief of a surface treated by a means of surface plastic deformation using an indenter fixed to an output end of an ultrasonic waveguide. The method provides periodical variation of high-frequency signal amplitude of ultrasonic transducer excitation for matching the kinematics of a tool movement to the kinematics of a motion of the ultrasonic waveguide output end thereof to form a given microrelief of a surface.

The given strengthening machining scheme ensures stable work at the amplitude of ultrasonic oscillations of an indenter from fractions to units of microns, because of the ultimate rigidity of the tool structure and the features of operation of the ultrasonic oscillation systems under load. A depth of strengthening is not specified in the Russian Patent No. 1,523,316, but such a low amplitude of oscillation enables the strengthening of a surface in a depth not more than 20 to 30 microns.

The described method does not take into account the factor of tilt angle change of the tool axis concerning the tangent to a workpiece surface at a current point of contact of an indenter with a surface during machining curved shaped surfaces. This circumstance leads to a vector direction change of impulses acting on a surface, and the corresponding change of the efficiency of machining.

Russian Patent No. 841,942 describes a tool which includes free deforming elements as balls rolling on a workpiece surface, conical, barrel-shaped or roller-shaped indenters. A set of indenters is set simultaneously in the cartridge, strictly appropriate to a shape and size of a workpiece surface. Using free indenters ensure enhanced efficiency of surface strengthening in comparison with the variant described above. However, the tool design described in the patent allows the machining of parts of just one standard size. Change in the shape and the size of a workpiece surface demands not only replacement of a pin holder, but a waveguide as well. The tool requires improved accuracy of mounting of the tool on a lathe, and imposes enhanced requirements to the accuracy of the lathe.

In the described tool design, a contact of the waveguide with deforming elements is pin-point or linear and hence the efficiency of the transmission of acoustic power from the waveguide to a workpiece surface is low. This condition does not enable accomplishing a high degree of ultrasonic strengthening.

The circumstances described above, reducing the efficiency of ultrasonic strengthening machining, are missing in the tool described in U.S. Pat. No. 6,458,225. This patent describes a method of ultrasonic impact machining (UIM) of friction surfaces of brake parts using a tool having free indenters. The patent also discloses a mechanism of surface strengthening and its microrelief improvement during realization of this method. The described UIM scheme is intended for machining of cylindrical surfaces only (e.g., on brake drums), or flat ring surfaces (e.g., on brake rotors). UIM of conical surfaces is also available using this scheme.

### OBJECTS AND SUMMARY OF THE INVENTION

The present invention relates to a method of ultrasonic impact machining (UIM) using free indenters which ensures effective enhancement of hardness, creation of compressive stresses, and modification of surface layer structure based upon diminishing of mosaic blocks up to an amorphous structure. As a consequence of these physical effects, UIM results in at least one of abrasive damage resistance improvement, contact injury resistance improvement, enhancement of corrosive damage resistance under stress, endurance improvement, enhancement of resistance to fatigue and dynamic fractures, creation of conditions for forming a surface with given physical and mechanical properties, and on this basis, abandonment of heat treatment of a material.

The necessity of strengthening surfaces of parts having shape, including a combination of different external and internal faces including cylindrical ones of different diameters, conical, front and curved faces of constant or varying radii, often occurs in the industry. UIM of surfaces formed by curved generatrices or straight generatrices with different tilt angles to the pivot pin, at constant orientation of the indenter axis concerning the workpiece pivot pin results in the changing of the machining efficiency with changing of the tangent tilt angle to the generatrix of a workpiece surface at the current point of treatment. The UIM method of the present invention provides uniform machining of these surfaces due to the tool axis orientation being substantially perpendicular to a workpiece surface at a current contact point independently of a form and its mechanical trajectory.

The efficiency of machining is preferably determined by UIM process variables such as: an amplitude of ultrasonic oscillations of the waveguide output end at a given ultrasonic oscillating frequency; a geometry and a mass of an indenter; a force of pressing the tool to a workpiece surface and a deflection rate of the pressing spring; a vector direction of deforming force impulses concerning a workpiece surface, caused by indenter impacts on this surface; a circumferential velocity at a contact point of an indenter with a workpiece surface; a feed rate of a lathe, and a number of working strokes. The parameters of strengthening treatment are preferably selected from mechanical properties of a workpiece material, workpiece surface geometry, machining process productivity and the main prescribed UIM results, determining a degree of workpiece life enhancement, which preferably includes a magnitude and a depth of induced compressive stresses propagation, a magnitude and a depth of enhanced microhardness propagation, a surface microrelief being formed, and a nature of treated material structural modification.

The present invention also comprises a method of selecting UIM parameters which provide a given efficiency of surface strengthening and forming of a prescribed relief of a strengthened surface. It is important in this method to take into account the curvature factor. The present invention also enables selection of tool design parameters, in particular clearances in the guide channel of an indenter, which provide a prescribed quality of surface strengthening machining.

The device provides realization of a method of machining at cutting machinery with numerical control (NC) by means of appropriate tool turning synchronous to its travel along the workpiece surface contour, providing the tool axis orientation being perpendicular to a workpiece surface at each point of its mechanical trajectory. In order to avoid the necessity of changing the machine control program, determining a mechanical trajectory of the tool during the UIM process, corresponding to a compound contour of a workpiece surface, the axis of a tool turn is required to pass through a current point of contact of an indenter with a workpiece surface.

### BRIEF DESCRIPTION OF THE DRAWINGS

Referring now to the drawings:

FIG. 1a-1c illustrate patterns of indenter indentations on a workpiece surface at different values of the lapping factor K.

FIG. 2 is a UIM tool of the present invention.

FIGS. 3a-3c show the influence of a clearance in a guide channel of an indenter on its parasitic oscillation when operating.

FIG. 4 is a schematic diagram of the inventive UIM method in use on a lathe with numerical control (NC).

### DETAILED DESCRIPTION OF THE PREFERRED EMBODIMENTS

The present invention relates to a method for ultrasonic impact machining (UIM) of surfaces of different curvatures using a rod-shaped indenter which is free in a direction of an oscillating system axis, executing ultrasonic impacts initiated by an action of the natural oscillations of a tool and resonance oscillations of an ultrasonic transducer, thereby providing uniform machining of external and internal surfaces with straight and curved shapes, with a goal of strengthening a surface. This method ensures effective enhancement of hardness, creation of compressive stresses, modification of surface layer structure based upon diminishing of mosaic blocks up to an amorphous structure. As a consequence of these physical effects, UIM of the present invention results in at least one of abrasive damage resistance improvement, contact injury resistance improvement, corrosive damage resistance enhancement under stress, endurance improvement, enhancement of resistance to fatigue and dynamic fractures, creation of conditions for forming a surface with prescribed physical and mechanical properties, and on this basis, abandonment of heat treatment of a material.

Uniform surface strengthening during the UIM process of the present invention is provided on a condition that the vector of force impulses caused by the indenter impacts on a workpiece surface is oriented perpendicular to the workpiece surface at each point of contact along a motion path of the tool independently of any configuration of the motion path. The maximal efficiency of machining is preferably ensured subject to the vector of force impulses which is directed perpendicularly to a tangent to a surface at a point of contact of an indenter with the surface. Hence, during the process of machining surfaces formed with curved generatrices or straight generatrices with different tilt angles to the pivot pin, it is necessary to turn the tool appropriately so that at a current point of contact of an indenter and a surface, an indenter can be oriented perpendicularly to tangents to a surface contour, and passed through a contact point. More particularly, an axis of the tool is preferably perpendicular to tangents, passing through a current point of contact between the tool and the workpiece surface, and wherein a tool pivot pin passes through the point perpendicularly to a workpiece axial section, passing through the point.

The main characteristics which preferably determine the UIM quality and ultimately the life time of a part include, but are not limited to: magnitude and depth of induced compressive stresses propagation, magnitude and depth of enhanced microhardness propagation, surface microrelief, and treated material structure. Value for each of these characteristics achieved due to UIM is preferably determined by the following process variables of strengthening and finishing treatment, individually and in combination: amplitude of ultrasonic oscillations of the waveguide output end at a given ultrasonic oscillating frequency; geometry and mass of an indenter; force of pressing the tool to a workpiece surface and deflection rate of the pressing spring; vector direction of deforming force impulses concerning a workpiece surface, caused by indenter impacts on the surface; circumferential velocity at a contact point of an indenter with a workpiece surface; feed rate of a lathe and number of working strokes. The UIM parameters are preferably predetermined in a prescribed order from the specified UIM results and preferably take into account the following preconditions: mechanical properties of a workpiece material, workpiece surface geometry, and machining process productivity.

During a first stage, the following treatment process variables are preferably selected: amplitude of ultrasonic oscillations of the waveguide output end at a given ultrasonic oscillating frequency; indenter mass, based on the given outlet parameters of a value of induced compressive stresses, which level must be at a given depth, not lower than a yield strength of workpiece material or a magnitude stipulated for it; and a degree of microhardness enhancement in the surface layer at a given depth up to a level not lower than 1.1 of the initial material microhardness, and taking into account the mechanical characteristics of the workpiece material. An indenter geometry is preferably selected based on the desired surface microrelief.

During a second stage, the required UIM productivity P and the lathe operating mode are preferably determined based on a workpiece surface area and the prescribed time of its machining. Machining productivity is preferably defined by the expression:
P=S/t,
where:
S is the workpiece surface area; and
t is the given processing time.
   The lathe operating mode includes the rotation speed of a workpiece and feed rate. When machining a cylindrical surface, the machining productivity P is associated with the lathe operating mode by the following expression:
   P=π·d·f·n,
   where:
d is the workpiece surface diameter;
f is lathe feed rate; and
n is the workpiece rotation speed.
   During machining of surfaces with varying diameters, a rotation speed is preferably predetermined so as to hold a constant circumferential velocity at a contact point of an indenter with a workpiece surface.

The process variables selected at the first stage enable evaluating a size of an indenter indentation on the workpiece material. The ratio between a total area of indentations in whole and a workpiece surface area is preferably designated as the lapping factor K, which is defined by the expression:
K=Σsᵢ/S,
where:
si is an area of an indentation.
   The lapping factor is preferably predetermined depending upon the required machining uniformity and a desired surface microrelief taking into account an earlier selected radius of an indenter working end. More particularly, the lapping factor and pattern of indentations are selected in accordance with a predetermined surface roughness of the workpiece and taking into account a radius of an indenter working end which provides a predetermined surface microreief.

A required frequency of impacts fᵢₘ determined at a third stage is defined by the expression:
f_{im.}=PK/Sᵢ.

At predetermined parameters (a tool non-stationary mass, mass and geometry of an indenter, vibrational amplitude of the waveguide output end, elastic properties of workpiece material, etc.), the frequency of impacts is preferably adjusted by a force of pressing the tool to a workpiece surface and a deflection rate of the pressing spring.

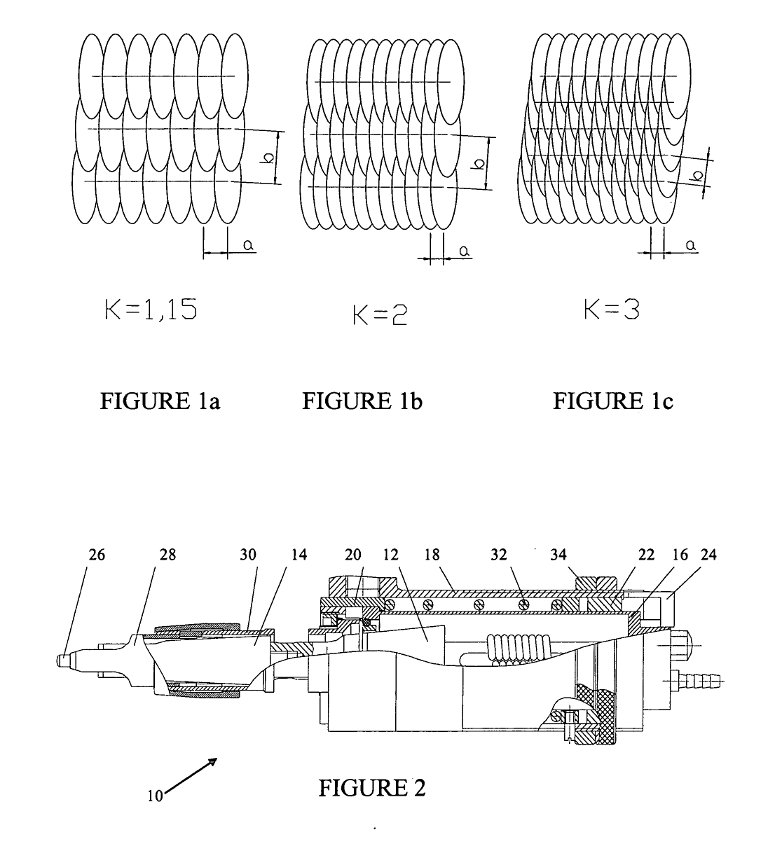

FIG. 1a-1c illustrate examples of patterns formed by indentations of an indenter on a workpiece surface having different values of the lapping factor K. The parameter a is preferably defined by a lathe feed rate f, the parameter b is preferably defined by the ratio between a circumferential velocity at point of a contact of an indenter and a workpiece surface, and a frequency of impacts fᵢₘ. A given microrelief of the workpiece surface is obtained by predetermining respective indenter radius, impact frequency and lapping factor as a function of the above-described treatment parameters including oscillating amplitude and tool speed.

The tool meeting requirements for a machine tool for a dimensional treatment is necessary for UIM realization. Accordingly, a tool design must be rigid enough to keep an accurate mounting under effect of static and dynamic work loads during the UIM process. Actuated parts of the tool must not have backlashes, decreasing the accuracy and quality of treatment. The tool must provide pressing of an indenter and an oscillating system to a workpiece surface with a prescribed force and adjustability. At the same time, damping of a dynamic load, occurring during treatment must be ensured. A tool design must provide quick and easy replacement of elements according to the service regulations, in particular indenters, a pin holder, and a waveguide.

The tool design meeting these requirements is shown in FIG. 2. An ultrasonic oscillating system of a tool 10 comprises a magnetostrictive transducer 12 and a waveguide 14, fixed by a zero clamp of the transducer 12 to a bowl 16, intended for liquid cooling of the transducer 12 during operation. The bowl 16 is preferably set in the body 18 by bronze guide bushes 20 and 22. When mounting the tool 10, the bushes 20,22 are being ground to a hole in the body 18 and the external diameter of the bowl 16 which provides lack of backlashes in actuated parts of the tool 10 and smoothed gliding of the oscillating system in the body 18 during the process of machining. The bowl 16 is preferably fixed with no ability to turn by means of a tab 24, rigidly fixed to the bowl 16 and gliding in the slot of the body 18.

An indenter 26 for striking directly at a workpiece surface is fixed to a holder 28, which is rigidly connected to the bowl 16 by a cup 30. The guide channel for an indenter 26 in the holder 28 is provided with a close tolerance, ensuring lack of backlash, which causes a reduction of accuracy and efficiency of machining. Pressing of the oscillating system and indenter 26 to a workpiece surface and dynamic load damping are performed by a spring 32. The pressing force is preferably adjusted by a female screw 34. The tool body 18 is preferably rigidly fixed to the lathe tool holder.

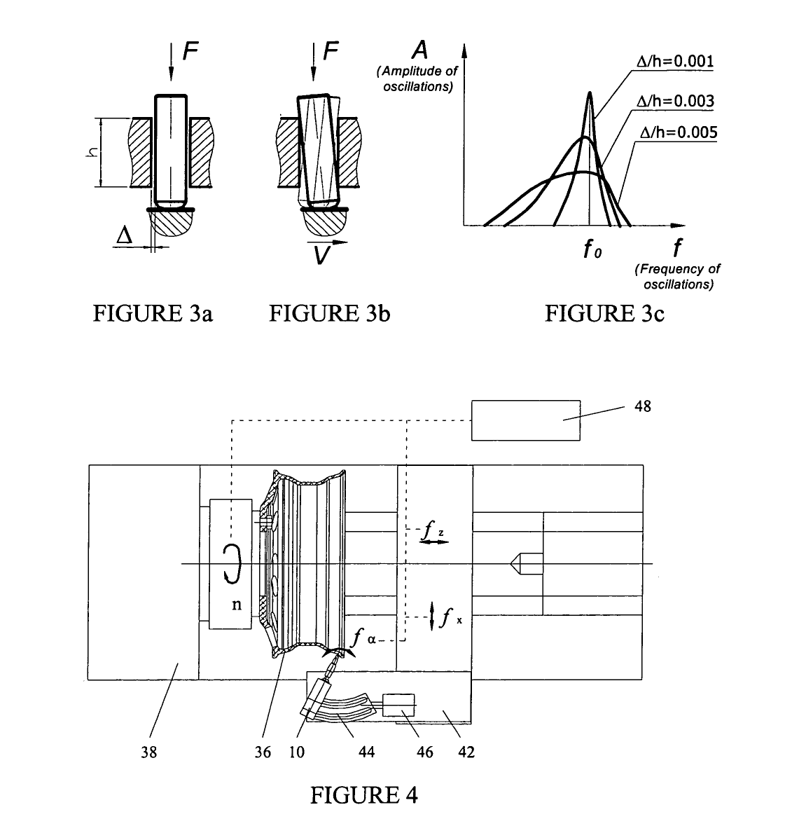

Strong requirements on accuracy are imposed in the production of machine actuated parts. FIGS. 3a-3c illustrate how clearance A between an internal wall of the guide channel in holder 28 and an indenter 26 affects the spectrum of the indenter's parasitic oscillation during the process of treatment. The clearance between the indenter and the internal wall of a guide channel, and a ratio between transverse dimensions of the guide channel and height of the guide channel are preferably chosen to exclude the occurrence of indenter parasitic oscillations and allow the indenter to freely travel along an oscillating system axis during ultrasonic impact machining process. Constructive and technological parameters influencing the frequency of indenter oscillations preferably include: length, diameter and mass of an indenter; a pressing force; non-stationary mass of a tool; amplitude of oscillations of the waveguide output end; linear velocity at a current point of contact of an indenter with a workpiece surface V; a workpiece surface relief; conditions of friction between an indenter and a workpiece surface; conditions of friction between an indenter and a surface of the guide channel; height h of the guide channel; and magnitude of clearance Δ in the guide channel.

The extent to which the two last constructive parameters have an affect, at constant values of other parameters, is shown in FIG. 3c in the plotted distribution of an indenter oscillating frequency during the process of treatment at varied values of ratio Δ/h. Diminution of this ratio provides for the reducing of indenter parasitic oscillation and, thus, diminishing energy loss and increasing the efficiency of treatment. At the same time, clearance must not allow jamming of the indenter in the holder as a result of thermal expansion when operating. Practically, when using an indenter of Ø6.35×25 mm and a height of 15 mm, the optimal clearance is Δ=10 to 17 μm.

A circuit schematic for realization of the present UIM method with a lathe having NC is shown in FIG. 4. A workpiece 36 is preferably fixed on a lathe 38, the workpiece surface being strengthened comprising cylindrical surfaces, conical surfaces and surfaces of rotation, having generatrices which are curves of constant or variable radii. To carry out UIM of the surface, an ultrasonic impact tool 10, including a rod-shaped indenter is fixed on the support 42 of the lathe 38.

The tool 10 is preferably fixed on a swing mechanism 44. The mechanical turning of the tool, which is respective to a workpiece surface curvature and perpendicular to it at the axial section at a current point of treatment, is occurring synchronously with the travel of the tool 10 along the curved contour of the workpiece 36 by means of the swing mechanism 44. The center of curved arcs of the guides of the swing mechanism 44 is preferably located in the point of contact of the indenter with the workpiece surface 36. The pivot pin of the tool 10 passes through a current point of contact of the indenter and the workpiece surface 36 and the pivot pin is also substantially perpendicular to the axial section of the workpiece 36, passing through this point. Superpositioning of the pivot pin of the tool 10 with the current point of treatment allows application of the lathe control program for UIM, which is used for turning the surface and determining a tool mechanical trajectory corresponding to the contour of the workpiece 36.

To turn the tool 10 in the guides of the swing mechanism 44 in coordination with travel along the contour of the workpiece 36, a drive 46 is preferably used which is mechanically connected with the swing mechanism 44 and electronically connected with programming device controlling lathe motions (NC) 48. Control of the drive 46 is preferably carried out from the NC system 48 according to a workpiece profile approximation algorithm. Thus, the NC system 48 provides coordinated principal travels of the lathe 38, rotation of the spindle n with a workpiece 36 fixed on it, longitudinal motion of the tool 10 f_{z}, transversal motion of the tool 10 fₓ and turning of the tool 10 fₐ.

The present scheme of UIM enables machining of both external and internal surfaces.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A method of surface plastic deformation of straight or curved surfaces of machining components on machine tools by a free rod-shaped indenter being a component of a tool for ultrasonic impact machining comprising:
executing on an external or internal, straight or curved surface of a workpiece ultrasonic impacts with said indenter free in a direction of an oscillating system axis, said impacts being initiated by natural oscillations of the tool and resonance oscillations of an ultrasonic transducer of the tool, and said indenter being oriented perpendicularly to the surface of the workpiece at a point of contact or motion of the tool to the surface independent of configuration of mechanical trajectory of the tool,
wherein said method provides at least one physical effect in said surface selected from increased surface layer hardness, creation of a high level of compressive stresses in the surface, and/or modifying surface structure based on diminishing mosaic blocks up to an amorphous structure, and
wherein said at least one physical effect results in at least one of increased abrasive damage resistance, increased contact injury resistance, increased corrosive damage resistance under stress, increased endurance, increased resistance to fatigue and dynamic fractures, creation of conditions for forming prescribed physical and mechanical properties in the surface.

2. The method of surface plastic deformation of claim 1, further comprising selecting an ultrasonic oscillating amplitude of a waveguide output end at a given ultrasonic oscillating frequency, and an indenter mass taking into account outlet parameters of machining as to magnitude of induced compressive stresses of a level at a given depth which is not lower than a yield strength of material of the workpiece or a magnitude stipulated therefor, and a value of microhardness which changes at a predetermined depth to a level of 1.1 and greater of initial material microhardness, thereby providing predetermined surface microrelief to the workpiece and a surface layer structure.

3. The method of surface plastic deformation of claim 1, further comprising selecting a lapping factor and a pattern of indentations to be provided during ultrasonic impact machining, wherein said lapping factor and pattern of indentations are selected in accordance with a predetermined surface roughness of the workpiece and taking into account a radius of an indenter working end, which provides a predetermined surface microrelief.

4. The method of surface plastic deformation of claim 2, further comprising selecting a lapping factor and a pattern of indentations to be provided during ultrasonic impact machining, wherein said lapping factor and pattern of indentations are selected in accordance with a predetermined surface roughness of the workpiece and taking into account a radius of an indenter working end, which provides a predetermined surface microrelief.

5. The method of surface plastic deformation of claim 3, further comprising selecting impact frequency during ultrasonic impact machining corresponding to said microrelief in order to provide said lapping factor.

6. The method of surface plastic deformation of claim 4, further comprising selecting impact frequency during ultrasonic impact machining corresponding to said microrelief in order to provide said lapping factor.

7. The method of surface plastic deformation of claim 1, wherein said tool includes a clearance between said indenter and an internal wall of a guide channel for said indenter, and said clearance and a ratio between transverse dimensions of said guide channel and a height of said guide channel are such so as to exclude parasitic oscillations occurrence by said indenter and cause said indenter to move along an oscillating system axis during ultrasonic impact machining.

8. The method of surface plastic deformation of claim 1, wherein movement of said tool is controlled by a numerically controlled cutting machine which provides mechanical turning of said tool which corresponds to a surface curvature of said workpiece and is perpendicular to said surface at axial section at a point of treatment, said mechanical turning being carried out synchronously with said tool moving along said surface curvature by means of a drive which has a kinematical connection with a swinging mechanism of said tool and electronic connection with a programmed device controlling movement of the cutting machine, wherein said electronic connection results from a workpiece surface approximation algorithm.

9. The method of surface plastic deformation of claim 8, wherein during treatment an axis of said tool is perpendicular to tangents which pass through a point of contact between said tool and said surface of the workpiece, and wherein a tool pivot pin passes through said point perpendicularly to a workpiece axial section, passing through said point.

10. A tool for conducting ultrasonic impact machining of straight or curved surfaces comprising:
a magnetostrictive transducer;
a waveguide;
an indenter; and
a holder of said indenter with a guide channel, wherein clearance is present between said indenter and an internal wall of said guide channel, and said guide channel is constructed to have a ratio between transverse dimensions of said guide channel and a height so as to exclude parasitic oscillations occurrence by said indenter and cause said indenter to move along an oscillating system axis during ultrasonic impact machining.

11. A processing system for conducting ultrasonic impact machining of straight or curved surfaces comprising:
a lathe with an electronic numerical control programming device;
an ultrasonic impact machining tool including an indenter;
a tool swing mechanism which is mounted on a movable support of said lathe and provides mechanical turning of said tool, said turning corresponding to surface curvature in a workpiece while maintaining said tool normal to said surface at axial section at a point of treatment, said mechanical turning being conducted synchronously with said tool moving along said surface curvature; and
a drive having a kinematical connection with said tool swing mechanism and electronic connection to said control programming device, said connection resulting from a workpiece surface approximation algorithm.

12. The cutting machine according to claim 11, wherein an axis of said tool is perpendicular to tangents which pass through a point of contact between said tool and said surface of the workpiece, and wherein a tool pivot pin passes through said point perpendicularly to a workpiece axial section, passing through said point.
